(19) United States
(12) Patent Application Publication
(10) Pub. No.: US 2026/0322681 A1
(43) Pub. Date: Oct. 15, 2026

(54) ADVANCED REFERENCE CLOCK SELECTION FOR NETWORK NODES

(71) Applicant: Nokia Solutions and Networks Oy, Espoo (FI)

(72) Inventors: Vinoth GOWTHAMAN, Kanata (CA); Shiva Sri Krishna DONTHI, Stittsville (CA); Peter ROBERTS, Ottawa (CA); Ross CLIFFORD, Kanata (CA); Kin Yee WONG, Ottawa (CA)

(73) Assignee: Nokia Solutions and Networks Oy, Espoo (FI)

(21) Appl. No.: 19/179,293

(22) Filed: Apr. 15, 2025

(51) Int. Cl. H04L 12/403

(52) U.S. Cl. CPC H04L 41/0668; H04L 7/0012; H04W 56/005

(57) ABSTRACT

A node in a computer network receives at least two reference clocks and performs pairwise comparisons between the at least two reference clocks to prioritize the reference clocks and select the highest priority reference clock to be the primary reference clock for the node. The node calculates and uses offsets between the primary reference clock and the other reference clocks to select a new primary reference clock in case of loss of the original primary reference clock. Each pairwise comparison can involve comparison of total accumulated time errors and/or comparison of steps removed between the two reference clocks to determine which of the two reference clocks has higher priority. The at least two reference clocks may be different types of reference clocks, such as GNSS clocks, PTP with FTS clocks, and/or PTP with PTS clocks.

### BACKGROUND

### Field of the Disclosure

The present disclosure relates to computer networks having multiple available reference clocks.

### Description of the Related Art

This section introduces aspects that may help facilitate a better understanding of the disclosure. Accordingly, the statements of this section are to be read in this light and are not to be understood as admissions about what is prior art or what is not prior art.

It is known for a node in a computer network to have one or more different available reference clocks. For example, a node may receive a first reference clock from a Global Navigation Satellite System (GNSS) and a second reference clock from a Precision Time Protocol (PTP) grandmaster of a PTP clock-distribution system conforming to the IEEE Std 1588™-2008 (or its revised version of IEEE Std 1588™-2019) standard, the teachings of which are incorporated herein by reference.

It is also known for the node to select one of the available reference clocks as its primary reference clock for its ongoing operations, while designating the other available reference clock as its secondary reference clock. It is further known for the node to calculate and update the offset between the primary and secondary reference clocks over time, such that, if and when the node loses the primary reference clock, the node can switch its ongoing operations to rely on the secondary reference clock, taking into account the current, calculated offset value to avoid a discontinuity in its ongoing reference clock.

It is also known to use a Best Time Transmitting Clock Algorithm (BTCA) to determine a relative priority between two different PTP clocks of the same type, for example, an FTS BTCA for two PTP with Full Timing Support (FTS) clocks or a PTS BTCA for two PTP with Partial Timing Support (PTS) clocks.

### SUMMARY

The present disclosure is related to algorithms for prioritizing between multiple reference clocks, where the algorithms handle situations in which the multiple reference clocks correspond to one or more types of clocks, where the different types of clocks include PTP with FTS clocks, PTP with PTS clocks, and/or GNSS clocks. The highest priority reference clock may be selected by a network node to be the primary reference clock for its ongoing operations with the one or more other clocks being secondary reference clocks. The node may calculate an offset between the primary reference clock and each secondary reference clock. In the event of loss of the selected, primary reference clock, the node may switch to one of the secondary reference clocks using the corresponding calculated offset value to minimize disruptions to ongoing operations both at the node and at downstream nodes that rely on the node's selected reference clock for their operations. When there are two or more secondary reference clocks, the node may select the secondary reference clock having the highest priority or the smallest calculated offset value to become the new selected, primary reference clock, depending on the implementation.

### BRIEF DESCRIPTION OF THE DRAWINGS

Embodiments of the disclosure will become more fully apparent from the following detailed description, the appended claims, and the accompanying drawings in which like reference numerals identify similar or identical elements.

FIG. 1 is a simplified hardware block diagram of a node for a computer network (not shown), according to certain embodiments of the present disclosure;

FIG. 2 is a flow diagram of the processing performed by the node of FIG. 1 on received reference clocks to select a reference clock to be used as the node's primary reference clock for its ongoing operations, according to certain embodiments of the disclosure; and

FIG. 3. is a flow diagram of an algorithm for prioritizing between a pair of reference clocks, according to certain embodiments of the disclosure.

### DETAILED DESCRIPTION

Detailed illustrative embodiments of the present disclosure are disclosed herein. However, specific structural and functional details disclosed herein are merely representative for purposes of describing example embodiments of the present disclosure. The present disclosure may be embodied in many alternate forms and should not be construed as limited to only the embodiments set forth herein. Further, the terminology used herein is for the purpose of describing particular embodiments only and is not intended to be limiting of example embodiments of the disclosure.

As used herein, the singular forms “a,” “an,” and “the,” are intended to include the plural forms as well, unless the context clearly indicates otherwise. It further will be understood that the terms “comprises,” “comprising,” “contains,” “containing,” “includes,” and/or “including,” specify the presence of stated features, steps, or components, but do not preclude the presence or addition of one or more other features, steps, or components. It also should be noted that in some alternative implementations, the functions/acts noted may occur out of the order noted in the figures. For example, two figures shown in succession may in fact be executed substantially concurrently or may sometimes be executed in the reverse order, depending upon the functions/acts involved.

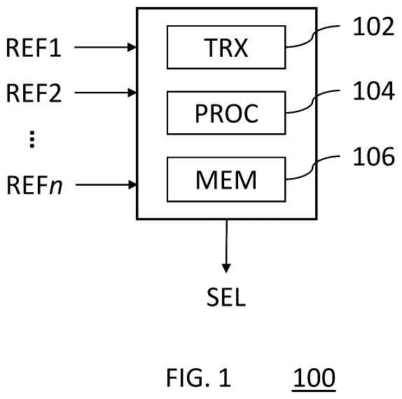

FIG. 1 is a simplified hardware block diagram of a node 100 for a computer network (not shown), according to certain embodiments of the present disclosure. As shown in FIG. 1, the node 100 includes (i) communication hardware (e.g., wireless, wireline, and/or optical transceivers (TRX)) 102 that supports communications with other nodes of the network, (ii) one or more processors (e.g., CPU and/or GPU microprocessors) 104 that control the operations of the node 100 and/or process data within the node 100, and (iii) one or more memories (e.g., RAM, ROM) 106 that store code executed by the processors 104 and/or data generated and/or received by the node 100.

As shown in FIG. 1, node 100 receives n reference clocks (REF1, REF2, . . . REFn), where n is an integer greater than 1, from one or more different clock sources (not shown in FIG. 1), where the n reference clocks correspond to one or more different types of clocks, where the different types of clocks include PTP with FTS clocks, PTP with PTS clocks, and/or GNSS clocks. For example, if n=2, then the different possible combinations of clocks include:
One PTP with PTS clock and one PTP with FTS clock;
One PTP with PTS clock and one GNSS clock;
One PTP with FTS clock and one GNSS clock;
Two PTP with PTS clocks;
Two PTP with FTS clocks; and
Two GNSS clocks.

Likewise, if n=3, then the different possible combinations of clocks include:
One PTP with PTS clock, one PTP with FTS clock, and one GNSS clock;
One PTP with PTS clock and two PTP with FTS clocks;
Two PTP with PTS clocks and one PTP with FTS clock;
One PTP with PTS clock and two GNSS clocks;
Two PTP with PTS clocks and one GNSS clock;
One PTP with FTS clock and two GNSS clocks;
Two PTP with FTS clocks and one GNSS clock;
Three PTP with PTS clocks;
Three PTP with FTS clocks; and
Three GNSS clocks.
   And so one, for values of n greater than three.

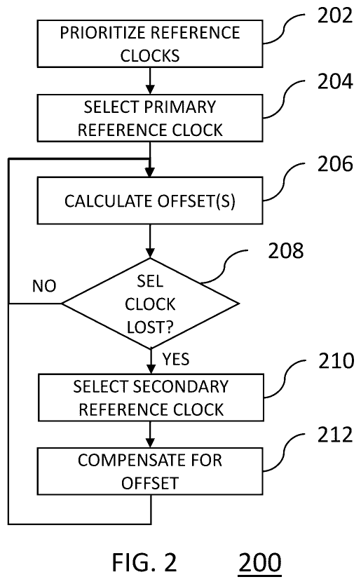

FIG. 2 is a flow diagram of the processing 200 performed by the node 100 of FIG. 1 on the n received, reference clocks (REF1, . . . , REFn) to select a reference clock (SEL) to be used as the node's primary reference clock for its ongoing operations, according to certain embodiments of the disclosure. In step 202, the node 100 performs a pairwise comparison between each pair of received, reference clocks to prioritize the reference clocks from highest priority to lowest priority. For example, in some embodiments, if there are three reference clocks REF1, REF2, and REF3, then the node 100 compares REF1 to REF2 to determine which of those two reference clocks has the higher priority, and likewise for REF2 and REF3 and for REF1 and REF3. Based on these three pairwise comparisons, the node 100 will be able to rank the three reference clocks from highest priority to lowest priority.

In step 204, the node 100 selects the highest-priority reference clock to be its primary reference clock for its ongoing operations with the one or more other reference clocks retained as secondary reference clocks, but not used for any ongoing operations.

In step 206, the node 100 generates an offset value between the selected, primary reference clock and each secondary reference clock.

In step 208, the node 100 determines whether the selected, primary reference clock has been lost. If not, then the processing 200 returns to step 206 to update each offset value, as needed. If the node 100 determines, in step 208, that the selected, primary reference clock has been lost, then, in step 210, the node 100 selects one of the secondary reference clocks to be its new primary reference clock for its ongoing operations. In some implementations, the node 100 selects the highest-priority secondary reference clock to be its new primary reference clock. In other implementations, the node 100 selects its new primary reference clock based on some other criterion, such as smallest offset value with respect to the original, primary reference clock.

In step 212, the node 100 compensates the newly selected, primary reference clock based on the corresponding offset value to avoid disruptions to its ongoing operations. The processing then returns to step 206 with the newly selected, primary reference clock and any remaining secondary reference clocks.

In some embodiments, if and when the original, selected reference clock returns, the processing 200 may return to step 202 to restart the entire process, which may result in the node 100 re-selecting the original, selected reference clock as the primary reference clock. Note that the node 100 will do so only after calculating the corresponding offset to avoid disruptions to its ongoing processing.

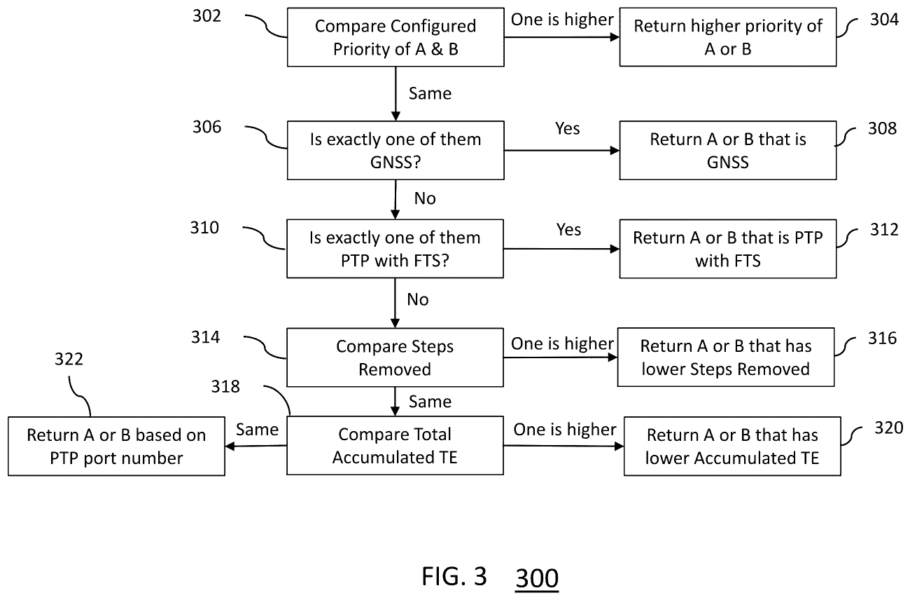

FIG. 3 is a flow diagram of an algorithm 300 for prioritizing between a pair of reference clocks referred to as Clock A and Clock B, according to certain embodiments of the disclosure. The algorithm 300 represents each pairwise comparison performed by the node 100 of FIG. A in step 202 of FIG. 2.

As known in the art, each reference clock is assigned a configurable priority value, where lower assigned values represent higher priority levels. The algorithm 300 starts at step 302 of FIG. 3 with the node 100 comparing the assigned priority values of Clocks A and B. If one of the clocks has a higher priority level (i.e., lower assigned priority value) than the other, then, in step 304, the node 100 prioritizes the clock with the higher assigned priority value, and the processing of the algorithm 300 ends. If Clocks A and B have the same priority level (i.e., the assigned priority values are equal), then the algorithm 300 proceeds to step 306.

In step 306, the node 100 determines whether exactly one of the clocks is a GNSS clock. If so, then, in step 308, the node 100 prioritizes that GNSS clock, and the processing of the algorithm 300 ends. Otherwise, the algorithm 300 proceeds to step 310.

In step 310, the node 100 determines whether exactly one of the clocks is a PTP with FTS clock. If so, then, in step 312, the node 100 prioritizes that PTP with FTS clock, and the processing of the algorithm 300 ends. Otherwise, the algorithm 300 proceeds to step 314.

In step 314, the node 100 compares the number of steps (stepsRemoved) involved in receiving Clock A from its source to the number of steps involved in receiving Clock B from its source. As known in the art, the number of steps involved in receiving a GNSS clock is zero, if the GNSS is local to the node 100, and one, otherwise, while the number of steps involved in receiving a PTP with FTS clock is one more than the number of hops between the PTP grandmaster time transmitter and the node 100. If the stepsRemoved of one of the clocks is less than the stepsRemoved of the other clock, then, in step 316, the node 100 prioritizes the clock with the lower stepsRemoved, and the processing of the algorithm 300 ends. If the stepsRemoved of Clock A is equal to the stepsRemoved of Clock B, then the algorithm 300 proceeds to step 318.

In step 318, the node 100 compares the total accumulated time error (accumulatedTE) of Clock A to the total accumulated time error of Clock B. As known in the art, the accumulatedTE of a GNSS clock is based on the particular type of GNSS clock, where the accumulatedTE for a GNSS PRTC-A clock is 100 nanoseconds, the accumulatedTE for a GNSS PRTC-B clock is 40 nanoseconds, and the accumulatedTE for a GNSS ePRTC clock is 30 nanoseconds. As also known in the art, the accumulatedTE for a PTP with FTS clock is a network-dependent value based on the total time error accumulated as PTP messages are transmitted, via zero, one, or more intermediate hops (i.e., transparent clocks), between the PTP with FTS clock's grandmaster time transmitter (not shown in the figures) and PTP with FTS time receiver (in this case, the node 100).

Referring again to step 318, if the accumulatedTE of Clock A is less than the accumulatedTE of Clock B, then, in step 320, the node 100 prioritizes the clock with the lower accumulatedTE, and the processing of the algorithm 300 ends. If the accumulatedTE of Clock A is equal to the accumulatedTE of Clock B or if the accumulatedTE for either clock is not available for some reason, then the algorithm 300 proceeds to step 322.

In step 322, the node 100 compares the assigned port identity of Clock A to the assigned port identity of Clock B. As known in the art, each reference clock arrives at the node 100 at a particular port having a corresponding port number, where the port identity for a reference clock is the port number of the corresponding port. If the port identity of Clock A is less than the port identity of Clock B, then the node 100 prioritizes Clock A, and the processing of the algorithm 300 ends. If the port identity of Clock B is less than the port identity of Clock A, then the node 100 prioritizes Clock B, and the processing of the algorithm 300 ends. If the port identity of Clock A is equal to the port identity of Clock B, then there is an error, and the processing of the algorithm 300 terminates without determining which clock has higher priority. Essentially, step 322 is an arbitrary tiebreaker for situations, for example, in which Clocks A and B have the same accumulatedTE and the same stepsRemoved.

The algorithm 300 is based on the following general principles: GNSS clocks are prioritized over PTP with FTS clocks, which are prioritized over PTP with PTS clocks. For clocks of the same type, the clock with the lower accumulated time error (accumatedTE) is prioritized.

Although the disclosure has been described in the context of the algorithm 300 of FIG. 3, those skilled in the art will understand that the disclosure can be implemented in the context of other suitable algorithms. For example, according to the algorithm 300 and some other suitable algorithms, the pairwise comparison of received, reference clocks can involve (i) a comparison of the total accumulated time error for the two reference clocks and/or (ii) a comparison of the steps removed for those two reference clocks.

Although the disclosure has been described in the context of systems having combinations of GNSS, PTP with FTS, and/or PTP with PTS clocks, those skilled in the art will understand that the disclosure is not limited to only combinations of one, two, or all three of those types of clocks and includes combinations that include one or more other suitable types of clocks, such as Coherent Network Primary Reference Time Clocks (cnPRTC) and Enhanced Precision Reference Clocks (ePRC).

In certain embodiments, the present disclosure is a node for a computer network. The node comprises at least one processor and at least one memory storing instructions that, upon being executed by the at least one processor, cause the node at least to receive at least first and second reference clocks; perform a pairwise comparison between the first and second reference clocks to determine a higher priority reference clock; and select one of the at least first and second reference clocks to be a primary reference clock for the node based on the determination.

In at least some of the above embodiments, the node is configured to receive more than two reference clocks; perform multiple pairwise comparisons to determine a highest priority clock; and select the highest priority clock to be the primary reference clock.

In at least some of the above embodiments, the first and second reference clocks are two different types of clocks selected from Global Navigation Satellite System (GNSS) clocks, Precision Time Protocol (PTP) with Full Timing Support (FTS) clocks, and PTP with Partial Timing Support (PTS) clocks.

In at least some of the above embodiments, the first reference clock is a GNSS clock, and the second reference clock is a PTP clock.

In at least some of the above embodiments, the first reference clock is a PTP with FTS clock, and the second reference clock is a PTP with PTS clock.

In at least some of the above embodiments, the node is configured to generate an offset between the primary reference clock and each other reference clock; detect loss of the primary reference clock; select another reference clock to be a new primary reference clock; and compensate the new primary reference clock based on the corresponding offset.

In at least some of the above embodiments, the node is configured to determine the higher priority reference clock based on a comparison of total accumulated time errors for the first and second reference clocks.

In at least some of the above embodiments, the node is configured to determine the higher priority reference clock based on a comparison of steps removed for the first and second reference clocks.

Unless explicitly stated otherwise, each numerical value and range should be interpreted as being approximate as if the word “about” or “approximately” preceded the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence. Likewise, additional steps may be included in such methods, and certain steps may be omitted or combined, in methods consistent with various embodiments of the disclosure.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred-to have to be in a corresponding order or sequence, either temporally, spatially, in ranking, or in any other manner.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements. The same type of distinction applies to the use of terms “attached” and “directly attached,” as applied to a description of a physical structure.

As used herein in reference to an element and a standard, the terms “compatible” and “conform” mean that the element communicates with other elements in a manner wholly or partially specified by the standard and would be recognized by other elements as sufficiently capable of communicating with the other elements in the manner specified by the standard. A compatible or conforming element does not need to operate internally in a manner specified by the standard.

The described embodiments are to be considered in all respects as only illustrative and not restrictive. In particular, the scope of the disclosure is indicated by the appended claims rather than by the description and figures herein. All changes that come within the meaning and range of equivalency of the claims are to be embraced within their scope.

The functions of the various elements shown in the figures, including any functional blocks labeled as “processors” and/or “controllers,” may be provided through the use of dedicated hardware as well as hardware capable of executing software in association with appropriate software. Upon being provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

It should be appreciated by those of ordinary skill in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

As will be appreciated by one of ordinary skill in the art, the present disclosure may be embodied as an apparatus (including, for example, a system, a network, a machine, a device, a computer program product, and/or the like), as a method (including, for example, a business process, a computer-implemented process, and/or the like), or as any combination of the foregoing. Accordingly, embodiments of the present disclosure may take the form of an entirely software-based embodiment (including firmware, resident software, micro-code, and the like), an entirely hardware embodiment, or an embodiment combining software and hardware aspects that may generally be referred to herein as a “system” or “network”.

Embodiments of the disclosure can be manifest in the form of methods and apparatuses for practicing those methods. Embodiments of the disclosure can also be manifest in the form of program code embodied in tangible media, such as magnetic recording media, optical recording media, solid state memory, floppy diskettes, CD-ROMs, hard drives, or any other non-transitory machine-readable storage medium, wherein, upon the program code being loaded into and executed by a machine, such as a computer, the machine becomes an apparatus for practicing the disclosure. Embodiments of the disclosure can also be manifest in the form of program code, for example, stored in a non-transitory machine-readable storage medium including being loaded into and/or executed by a machine, wherein, upon the program code being loaded into and executed by a machine, such as a computer, the machine becomes an apparatus for practicing the disclosure. Upon being implemented on a general-purpose processor, the program code segments combine with the processor to provide a unique device that operates analogously to specific logic circuits. The term “non-transitory,” as used herein, is a limitation of the medium itself (i.e., tangible, not a signal) as opposed to a limitation on data storage persistency (e.g., RAM vs. ROM).

Signals and corresponding terminals, nodes, ports, links, interfaces, or paths may be referred to by the same name and/or label and are interchangeable for purposes here.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements. For example, the phrases “at least one of A and B” and “at least one of A or B” are both to be interpreted to have the same meaning, encompassing the following three possibilities: 1—only A; 2—only B; 3—both A and B.

All documents mentioned herein are hereby incorporated by reference in their entirety or alternatively to provide the disclosure for which they were specifically relied upon.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

As used herein and in the claims, the term “provide” with respect to an apparatus or with respect to a system, device, or component encompasses designing or fabricating the apparatus, system, device, or component; causing the apparatus, system, device, or component to be designed or fabricated; and/or obtaining the apparatus, system, device, or component by purchase, lease, rental, or other contractual arrangement.

While preferred embodiments of the disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the technology of the disclosure. It is intended that the following claims define the scope of the invention and that methods and structures within the scope of these claims and their equivalents be covered thereby.

What is claimed is:

1. A node for a computer network, the node comprising:
at least one processor; and
at least one memory storing instructions that, upon being executed by the at least one processor, cause the node at least to:
receive at least first and second reference clocks;
perform a pairwise comparison between the first and second reference clocks to determine a higher priority reference clock; and
select one of the at least first and second reference clocks to be a primary reference clock for the node based on the determination.

2. The node of claim 1, wherein the node is configured to:
receive more than two reference clocks;
perform multiple pairwise comparisons to determine a highest priority clock; and
select the highest priority clock to be the primary reference clock.

3. The node of claim 1, wherein the first and second reference clocks are two different types of clocks selected from Global Navigation Satellite System (GNSS) clocks, Precision Time Protocol (PTP) with Full Timing Support (FTS) clocks, and PTP with Partial Timing Support (PTS) clocks.

4. The node of claim 3, wherein the first reference clock is a GNSS clock, and the second reference clock is a PTP clock.

5. The node of claim 3, wherein the first reference clock is a PTP with FTS clock, and the second reference clock is a PTP with PTS clock.

6. The node of claim 1, wherein the node is configured to:
generate an offset between the primary reference clock and each other reference clock;
detect loss of the primary reference clock;
select another reference clock to be a new primary reference clock; and
compensate the new primary reference clock based on the corresponding offset.

7. The node of claim 1, wherein the node is configured to determine the higher priority reference clock based on a comparison of total accumulated time errors for the first and second reference clocks.

8. The node of claim 7, wherein the node is configured to determine the higher priority reference clock based on a comparison of steps removed for the first and second reference clocks.

9. The node of claim 1, wherein the node is configured to determine the higher priority reference clock based on a comparison of steps removed for the first and second reference clocks.

10. A method for a node for a computer network, the method comprising the node:
receiving at least first and second reference clocks;
performing a pairwise comparison between the first and second reference clocks to determine a higher priority reference clock; and
selecting one of the at least first and second reference clocks to be a primary reference clock for the node based on the determination.

11. The method of claim 10, wherein the node:
receives more than two reference clocks;
performs multiple pairwise comparisons to determine a highest priority clock; and
selects the highest priority clock to be the primary reference clock.

12. The method of claim 10, wherein the first and second reference clocks are two different types of clocks selected from GNSS clocks, PTP with FTS clocks, and PTP with PTS clocks.

13. The method of claim 12, wherein the first reference clock is a GNSS clock, and the second reference clock is a PTP clock.

14. The method of claim 12, wherein the first reference clock is a PTP with FTS clock, and the second reference clock is a PTP with PTS clock.

15. The method of claim 10, wherein the node:
generates an offset between the primary reference clock and each other reference clock;
detects loss of the primary reference clock;
selects another reference clock to be a new primary reference clock; and
compensates the new primary reference clock based on the corresponding offset.

16. The method of claim 10, wherein the node determines the higher priority reference clock based on a comparison of total accumulated time errors for the first and second reference clocks.

17. The method of claim 16, wherein the node determines the higher priority reference clock based on a comparison of steps removed for the first and second reference clocks.

18. The method of claim 10, wherein the node determines the higher priority reference clock based on a comparison of steps removed for the first and second reference clocks.
